(19) United States
(12) Patent Application Publication
(10) Pub. No.: US 2024/0059723 A1
(43) Pub. Date: Feb. 22, 2024

(54) CHELATOR-MEDIATED FENTON (CMF) PROCESS TO BREAK A C-C BOND IN LIGNOSULFONATE

(71) Applicant: NATIONAL TECHNOLOGY & ENGINEERING SOLUTIONS OF SANDIA, LLC, Albuquerque, NM (US)

(72) Inventor: Michael S. KENT, Albuquerque, NM (US)

(21) Appl. No.: 18/494,513

(22) Filed: Oct. 25, 2023

Related U.S. Application Data
(63) Continuation of application No. PCT/US2022/026407, filed on Apr. 26, 2022.
(60) Provisional application No. 63/180,030, filed on Apr. 26, 2021.

(51) Int. Cl. C07G 1/00

(52) U.S. Cl. CPC C07G 1/00

(57) ABSTRACT

The present invention provides for a method to break a C—C bond in lignosulfonate, the method comprising: (a) optionally sulfonating a lignin to produce a lignosulfonate, (b) contacting a chelator/Fe complex or a Fe(II) cation with a lignosulfonate to produce a reaction mixture, (c) incubating the reaction mixture for a suitable period of time wherein at least one C—C bond in a lignosulfonate is broken, (d) optionally introducing an oxidizing agent to the reaction mixture, and (e) optionally separating two separate molecules formed from breaking the C—C bond of lignosulfonate.

### RELATED PATENT APPLICATIONS

This application claims priority as a continuation application to PCT International Patent Application No. PCT/US2022/026407, filed Apr. 26, 2022, which claims priority to U.S. Provisional Patent Application Ser. No. 63/180,030, filed on Apr. 26, 2021, which are both hereby incorporated by reference.

### STATEMENT OF GOVERNMENTAL SUPPORT

The invention was made with government support under Contract Nos. DE-AC02-05CH11231 awarded by the U.S. Department of Energy. The government has certain rights in the invention.

### FIELD OF THE INVENTION

The present invention is in the field of modification of lignin.

### BACKGROUND OF THE INVENTION

Lignin constitutes about 15-30% of the dry weight of plant biomass and is comprised mostly of three monolignols that are polymerized through a variety of interunit C—C and C—O linkages in an irregular fashion. Lignin provides structural integrity to the plant cell walls, and consequently is highly resistant to breakdown. Yet removing, altering, or depolymerizing lignin is critical to lignocellulosic biomass-based industries. Furthermore, generating value from lignin has the potential to contribute significantly to the overall economic viability of a lignocellulosic biorefinery.[1-3]

Due to the structural and chemical complexity of lignin, depolymerization inevitably leads to a distribution of breakdown products[4-6]. Separating components of the complex mixture for upgrading is difficult and expensive. Biological conversion is a promising approach to deal with the complexity of the lignin breakdown products.[7-12] Yet this approach has its own challenges, such as integrating depolymerization processes with fermentation, toxicity of some of the breakdown products, a limited molecular weight range for rapid internalization by bacteria or fungi, and engineering pathways in microbes to funnel the carbon to useful products or intermediates.

Much prior work to depolymerize lignin has focused on cleaving ether bonds to release aromatic monomers [13-19]. However, C—C bonds make up a significant fraction of native lignin linkages and are increased substantially during most common extraction processes. For lignins with 50% β-O-4 content, in theory only about 50% of the lignin can be released as monomers and dimers through cleaving ether bonds and in practice the yield is much lower, typically in the range of 20% or less [20, 21]. Higher monomer yields have been achieved for lignins containing higher β-O-4 content (50-70%) through lignin-first processing of intact biomass thereby avoiding isolation processes that result in condensation [17, 22-25] or by altering the natural lignin synthetic pathways [14]. Catalytic approaches performed at high temperature and high pressure may cleave some C—C bonds along with C—O bonds which would also contribute to increased monomer yields [4, 25-27]. The monomer yield can be limited by the tendency for repolymerization of the breakdown products, although this problem has been reduced through the use of protecting groups [14, 28] or careful control of catalyst and conditions [25]. However, significant economic challenges accompany the higher monomer yields with lignin-first approaches and for catalytic approaches at high temperature and high pressure. Enzymes have also been explored for lignin depolymerization, motivated by natural lignocellulose breakdown processes, but so far have resulted in very low monomer yields and are also plagued by repolymerization of the breakdown products [5, 29-32]. There is a need for economical high yield depolymerization strategies for condensed lignins that result from carbohydrate-first pretreatment processes.

Areskogh et al. (“Chemical Pulping: Fenton's reaction: a simple and versatile method to structurally modify commercial lignosulphonates”, Nordic Pulp and Paper Research Journal, 26:90, 2011) reported that use of aggressive Fenton reaction conditions can result in polymerization of lignosulfonate (LS), and that some depolymerization at low LS concentrations but their focus is on using lignin as a polymeric dispersant of cement particles in concrete production. Prior work has shown that the Fenton reaction can depolymerize sulfonated polystyrene (PLoS ONE 10: e0131773, 2015; Environ. Sci. Technol. 2011, 45, 744) and sulfonated polyethylene (Chem. Eur. J. 2016, 22, 9513).

U.S. Patent Application Publication No. 2019/0002490 (Michael Kent) discloses a method to modify a lignin comprising: (a) mixing a lignin, a chelator, and FeCl₃ to produce a first solution, (b) optionally incubating the solution for a first suitable period of time, (c) introducing an oxidizing agent to the first solution to produce a second solution, and (d) optionally incubating the solution for a second suitable period of time; such that at least one aromatic ring of one lignin polymer is opened.

### SUMMARY OF THE INVENTION

The present invention provides for a method to break a C—C bond in lignosulfonate, the method comprising: (a) optionally sulfonating a lignin to produce a lignosulfonate, (b) contacting a chelator/Fe complex or a Fe(II) cation with a lignosulfonate to produce a reaction mixture, (c) incubating the reaction mixture for a suitable period of time wherein at least one C—C bond in a lignosulfonate is broken, (d) optionally introducing an oxidizing agent to the reaction mixture, and (e) optionally separating two separate molecules formed from breaking the C—C bond of lignosulfonate.

The present invention provides for any of the solutions or mixtures formed in any of the steps of the present invention.

The present invention provides for a mixture of lignosulfonate with C—C bonds broken by the method of the present invention.

This present invention provides for a method depolymerize lignin for biological conversion into useful chemicals and intermediates. In some embodiments, the method comprises a step to sulfonate lignin such that the chelator-mediated Fenton (CMF) reaction is performed on sulfonated lignin. CMF reaction is much more efficient at breaking carbon-carbon bonds and decreasing the molecular weight of lignin when the lignin is sulfonated. Since the reaction is performed in aqueous solution it is suitable for directly feeding into a bioreactor for biological conversion.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows the chemical structures of (a) polystyrene sulfonate, and (b) lignosulfonate.

FIG. 2. (a, b) Molecular weight change for 5 mg/mL PSS 67K at 1 mM FeCl₃-DHB and 0.5% H₂O₂ (210 nm and 270 nm). (c, d) Molecular weight change for 5 mg PSS 5.2K at 1 mM FeCl₃-DHB and 0.5% H₂O₂ (210 nm and 270 nm).

FIG. 3 shows post-reaction Mw for PSS 5.2K as a function of (a) [FeCl₃] ([H₂O₂]=1%), (b) [PSS] ([FeCl₃]=10 mM, [H₂O₂]=1%), (c) [H₂O₂] ([FeCl₃]=5 mM), and (d) temperature ([FeCl₃]=1 mM, [H₂O₂]=0.5%). Unless otherwise indicated, [LS]=5 mg/mL, [DHB]=4 mM, and T=room temperature.

FIG. 4 shows FTIR spectra for PSS 5.2K and after reaction with [FeCl₃]=[DHB]=1 mM, [H₂O₂]=1%, at room temperature.

FIG. 5 shows molecular weight distribution for LS at 5 mg/mL before and after reaction with [FeCl₃]=[DHB]=0.5 mM and [H₂O₂]=0.5% at room temperature.

FIG. 6 shows post-reaction Mw for LS as a function of (a) [FeCl₃] ([H₂O₂]=1%), (b) [LS] ([FeCl₃]=10 mg/mL, [H₂O₂]=1%), (c) [H₂O₂] ([FeCl₃]=5 mM), and (d) temperature ([FeCl₃]=1 mM, [H₂O₂]=0.5%). Unless otherwise indicated, [LS]=5 mg/mL, [DHB]=4 mM, and T=room temperature.

FIG. 7 shows FTIR spectra for LS as a function of [LS] (a, b) with [H₂O₂]=0.5%, and as a function of [H₂O₂] (c, d) with 5 mg/mL LS. Reactions were performed with [FeCl₃]=[DHB]=0.5 mM at 40° C.

FIG. 8 shows two dimensional ¹H-¹³C HSQC NMR spectra for (a) LS and (b) depolymerization products for CMF reaction of LS with [FeCl₃]=1 mM, [DHB]=10 mM, [H₂O₂]=1% at 40° C. The aliphatic region is expanded and overlaid for the two samples in (c), with the post-reaction spectra shown in red.

FIG. 9 shows quantitative ¹³C NMR (top) and INEPT NMR spectra (bottom) for depolymerization products of CMF reaction of LS with [FeCl₃]=1 mM, [DHB]=10 mM, [H₂O₂]=1% at 40° C.

FIG. 10 shows growth of monocultures in the LS breakdown stream or base medium in the presence or absence of glucose.

FIG. 11 shows the Fenton reaction depolymerization of sulfonated lignin at room temperature in aqueous solution.

FIG. 12 shows a method of depolymerizing lignin for biological conversion through sulfonation and Fenton chemistry.

FIG. 13 shows the depolymerization of lignin for biological conversion through sulfonation and Fenton chemistry.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “about” includes any value up to 10% less or 10% more inclusive of the value provided.

The term “lignin” also includes the meaning of a mixture of different lignin polymers.

In some embodiments, the method comprises: (a) sulfonating a lignin to produce a lignosulfonate, (b) contacting a chelator/Fe complex or a Fe(II) cation with a lignosulfonate to produce a reaction mixture, and (c) incubating the reaction mixture for a suitable period of time wherein at least one C—C bond in a lignosulfonate is broken.

Lignin can be sulfonated in any suitable method, such as methods described in Aro et al. “Production and Application of Lignosulfonates and Sulfonated Lignin”, Chem. Sus. Chem. 10(9): 1861-1877, 2017 (hereby incorporated by reference). In some embodiments, lignin is sulfonated by contacting a sulfate or sulfite, such as acidic sulfite, calcium sulfite, or sodium sulfite, or a sulfuric acid, and optimally contacting with a base, such as sodium hydroxide or calcium oxide, with a lignin. Lignin can also be sulfonated in any suitable method, such as methods described in Huang et al. “Preparation of Lignosulfonates from Biorefinery Lignins by Sulfomethlyation and Their Application as a Water Reducer for Concrete”, Polymers 10: 841, 2018 (hereby incorporated by reference). In some embodiments, lignin is sulfonated by contacting a lignin with a base, such as a sodium hydroxide, and then a hydroxymethylsulfonate, such as a sodium hydroxymethylsulfonate. In some embodiments, lignin is sulfonated by sulfite pulping of a lignin.

In some embodiments, the method comprises, after the sulfonating step, separating or removing any, or about all sulfate or sulfite, such as acidic sulfite, calcium sulfite, or sodium sulfite, or a sulfuric acid, and optimally the base, such as sodium hydroxide or calcium oxide, from the lignin and/or lignosulfonate, or mixture thereof. In some embodiments, the removing step comprises dialyzing the lignin and/or lignosulfonate, or mixture thereof, to separate or remove the sulfate or sulfite, such as acidic sulfite, calcium sulfite, or sodium sulfite, or a sulfuric acid, and optimally the base, such as sodium hydroxide or calcium oxide.

In some embodiments, the method comprises, between the sulfonating step and separating or removing step, a diluting the lignin and/or lignosulfonate, or mixture thereof, in a mixture or solution, such as an aqueous solution. In some embodiments, the diluting step comprises adding water to the mixture or solution.

In some embodiments, the method comprises, after the incubating step, comprises a diluting the lignin and/or lignosulfonate, or mixture thereof, in the reaction mixture. In some embodiments, the diluting step comprises adding water to the reaction mixture.

In some embodiments, the sulfonated lignin is a lignin comprising a —SO₃⁻, —SO₃-alkyl, or a mixture thereof. In some embodiments, the alkyl is a methyl, ethyl, propyl, butyl, pentyl, tert-butyl, or any alkyl with at 1 to 10 carbon atoms.

In some embodiments, the method further comprises: contacting a Fe salt and a chelator to form the chelator/Fe complex. In some embodiments, the contacting a Fe salt and a chelator step occurs prior to concurrently with contacting step (a). In some embodiments, the chelator/Fe complex is formed by the contacting a Fe(III) salt with a chelator.

In some embodiments, the chelator is 1,2-dihydroxybenzene (DHB). In some embodiments, the Fe salt is any Fe(II) salt or Fe(III) salt, such as FeX₃, (wherein X is any halide, such as F, Cl, Br, or I), Fe₂(SO₄)₃, Fe(NO₃)₃, or the like. In some embodiments, the Fe salt is iron (II) perchlorate (Fe(ClO₄)₂), iron(II) phosphate (FePO₄), iron(III) pyrophosphate (Fe₄(P₂O₇)₃), iron(II) pyrophosphate, iron(II) sulfate (FeSO₄), ammonium iron(II) sulfate, iron(II) bromide, iron(III) bromide, iron(II) chloride (FeCl₂), iron(III) chloride (FeCl₃), iron(II) fluoride, iron(III) fluoride, iron(III) nitrate, iron(II) oxalate, iron(III) oxalate, or a hydrate thereof, or a mixture thereof. In some embodiments, the Fe salt contains has at least 99.9%, 99.99%, or 99.999% purity trace metal basis.

In some embodiments, the average molecular weight of the lignosulfonate in the reaction mixture is decreased. In some embodiments, the breaking of the C—C bond results in two separate molecules from the lignosulfonate.

In some embodiments, the chelator is any chelator that can chelate Fe to facilitate the reduction of Fe(III) to Fe(II). The chelator/Fe complex is formed by the contact of a Fe salt and a chelator. In some embodiments, the chelator is 1,2-dihydroxybenzene (DHB), 2,3-dihydroxybenzoic acid (DHBA), pyrogallol, or a mixture thereof.

In some embodiments, the method results in at least about 10%, 20%, 30%, 40%, 50%, 60%, 70%, 80%, 90%, 95%, or 99%, or essentially about 100% of the lignosulfonate in the reaction mixture has at least's a C—C bond broken, or has an average of at least one C—C bond broken.

In some embodiments, the method results in the mean, median, or maximal or local maximal molecular weight of the lignosulfonate is reduced equal to or more than about 5, 10, 15, 20, 25, 30, 31, 32, 33, 34, 35, 36, 37, 38, 39, or 40-fold, or any range within two preceding values thereof. In some embodiments, the method results in the mean, median, or maximal or local maximal molecular weight of the lignosulfonate is reduced equal to or more than about 0.1, 0.2, 0.3, 0.4, 0.5, 0.6, 0.7, 0.8, 0.9, or 1.0 magnitude, or any range within two preceding values thereof. In some embodiments, the method results in the mean, median, or maximal or local maximal molecular weight of the lignosulfonate is reduced from about 28,000 g/mol to equal to or less than about 770 g/mol, or from about 5,400 g/mol to equal to or less than about 140 g/mol.

at least about 10%, 20%, 30%, 40%, 50%, 60%, 70%, 80%, 90%, 95%, or 99%, or essentially about 100% of the lignosulfonate in the reaction mixture has at least's a C—C bond broken, or has an average of at least one C—C bond broken.

In some embodiments, the water-insoluble lignin is part of a solid component that is equal to or more than about 20% by weight of the reaction mixture. In some embodiments, the water-insoluble lignin is part of a solid component that is equal to or more than about 25%, 30%, 35%, 40%, 45%, or 50% by weight of the first solution. In some embodiments, the solid component is a biomass.

In some embodiments, the introducing step (d), introducing step (e), and/or repeating step (f), and any other steps described herein, are continuous or semi-continuous.

In some embodiments, the method comprises: (a) contacting a chelator/Fe complex with a lignosulfonate to produce a reaction mixture, (b) introducing an oxidizing agent to the reaction mixture, (c) incubating the reaction mixture for a suitable period of time, (d) introducing further lignosulfonate to the reaction mixture during step (c); (e) introducing further oxidizing agent to the reaction mixture incubating step (c); and (f) optionally repeating step (d) and/or step (e) one or more times.

In some embodiments, the method comprises: contacting a Fe salt and a chelator to form the chelator/Fe complex. In some embodiments, the contacting a Fe salt and a chelator step occurs prior to concurrently with contacting step (a). In some embodiments, the chelator/Fe complex is formed by the contacting a Fe(III) salt with a chelator.

In some embodiments, the suitable period of time is at least about 1, 2, 3, 4, 5, 6, or 7 days.

In some embodiments, the incubating step (c) takes place at a temperature of about room temperature or 25° C.

In some embodiments, the introducing step (b) and/or introducing step (e) comprise bubbling a gas composition comprising O₂ into the reaction mixture. In some embodiments, the gas composition comprises at least about 20% of O₂. In some embodiments, the gas composition comprises essentially 100% of O₂. In some embodiments, the oxidizing agent is H₂O₂ or molecular oxygen (O₂), or both.

In some embodiments, the gas composition is bubbled through the reaction mixture at a rate of at least about 0.01 standard cubic feet per hour (SCFH). In some embodiments, the gas composition is bubbled through the reaction mixture at a rate of at least about 0.05 standard cubic feet per hour (SCFH). In some embodiments, the introducing step (b) and/or introducing step (e) result in at least about 0.1%, 0.2%, 0.3%, 0.4%, or 0.5%, or any value within any of the preceding two values, of [oxidizing agent]₀.

In some embodiments, two separate molecules are formed from the breaking of a C—C bond of a lignosulfonate. In some embodiments, the two separate molecules, formed from breaking the C—C bond of lignosulfonate, each has a different molecular weight from each other. In some embodiments, the two separate molecules are formed from two different lignosulfonate molecules.

In some embodiments, the Fe concentration added to the reaction mixture has a concentration equal to or higher than about 10 mM, 15 mM, 20 mM, 25 mM, 30 mM, 35 mM, 40 mM, 45 mM, or 50 mM, or having a value within any two preceding values. In some embodiments, the concentration or chelator/Fe complex or Fe salt in the reaction mixture is increased by introducing more chelator/Fe complex or Fe salt to the reaction mixture. In some embodiments, introducing more chelator/Fe complex or Fe salt brings the total concentration of chelator/Fe complex or Fe salt to a concentration equal to or higher than about 10 mM, 15 mM, 20 mM, 25 mM, 30 mM, 35 mM, 40 mM, 45 mM, or 50 mM, or having a value within any two preceding values, in the reaction mixture. The high concentration of iron (10 mM or more) increases the average MW of lignosulfonate or lignin, or a mixture thereof.

In some embodiments, the lignin is obtained from pretreatment of a biomass. In some embodiments, the lignin has a concentration of from about 1 mg/mL to about 100 mg/mL. In some embodiments, the lignin has a concentration of from about 1 mg/mL to about 50 mg/mL. In some embodiments, the chelator is 1,2-dihydroxybenzene (DHB) or 1,2-benzenediol, or any DHB further substituted with one or more hydroxyl groups, such as 1,2,3-trihydroxybenzene and 1,2,3,4-tetrahydroxybenzene. In some embodiments, the Fe salt has a concentration of from about 0.1 mM to about 10 mM. In some embodiments, the Fe salt has a concentration of from about 0.5 mM to about 4 or 5 mM. In some embodiments, the first suitable period of time and second suitable period of time is from about 24 hours to about 48 hours, optionally at about room temperature. In some embodiments, the H₂O₂ has a concentration of from about 0.1% to about 10% mg/mL. In some embodiments, the H₂O₂ has a concentration of from about 0.5% to about 5% mg/mL.

In some embodiments, the method comprises the following: Preparing an equimolar stock solution of dihydroxybenzene (DHB) and a Fe salt (typically 10 mM) in water at pH 3. Allowing the solution to incubate at least 30 min results in the formation of DHB/Fe(III) complexes. Using that stock solution to prepare a solution of 4 mM DHB/Fe(III) complexes in water at pH 3 containing lignin. Stirring the mixture vigorously for a minimum of several hours (typically overnight). Then adding hydrogen peroxide (H₂O₂) at 0.5% (5 mg/ml) and allow the reaction to proceed to completion. The time required for completion varies with the amount of lignin. This results in nearly complete conversion of the water-insoluble lignin into an aqueous solution of lignin breakdown products at pH 3. The product distribution (size and chemical nature of the lignin-derived molecular fragments) will vary with the amount of lignin used as well as with the reaction time. In some embodiments, the method comprises the use of 4 mM DHB, 4 mM, FeCl₃, 5 mg/ml H₂O₂, and lignin content ranging from 2.5 mg per ml of solution to 12.5 mg per ml of solution.

This present invention provides for a method depolymerize lignin for biological conversion into useful chemicals and intermediates. In some embodiments, the method comprises a step to sulfonate lignin such that the chelator-mediated Fenton (CMF) reaction is performed on sulfonated lignin. CMF reaction is much more efficient at breaking carbon-carbon bonds and decreasing the molecular weight of lignin when the lignin is sulfonated. Since the reaction is performed in aqueous solution it is suitable for directly feeding into a bioreactor for biological conversion.

Similar inventions are disclosed by U.S. 2019/0002490A1, and U.S. Provisional Patent Application Ser. No. 63/173,478, which is hereby incorporated by reference.

One aspect of the invention is that large molecular weight reductions of lignin are achieved by combining chelator-mediated Fenton chemistry with sulfonation of lignin. In some embodiments, the method results in a reduction of MW of the lignosulfonate of at least about 0.5, 1.0, 1.5, or 2.5 orders of magnitude. In some embodiments, the preceding reduction of MW is done wherein the lignosulfonate is processed at about 5 mg/ml using at least about 0.5% H₂O₂, 0.5 mM iron(III) salt, such as FeCl₃, 0.5 mM chelator, such as dihydroxybenzene (DHB), at about 40° C. In some embodiments, the reaction is performed for a range of H₂O₂ concentrations of at least about 0.1% to 0.5%. In some embodiments, at least about 0.1% H₂O₂, the Mw is reduced by a factor of at least about 10. In some embodiments, the reaction is performed with a lignosulfonate concentration at least about from 5 mg/ml to 25 mg/ml.

In some embodiments, the method results in depolymerizing lignosulfonate, and does not result in repolymerizing of the lignosulfonate. The ability to depolymerize lignosulfonate means that there is a means to depolymerize lignin, which in turn means that engineered microorganisms can take up the fragments (of depolymerized LS or lignin) and convert the carbon into useful chemicals and intermediates. This may greatly improve the overall economics of lignocellulosic biorefineries.

In some embodiments, the method is performed in aqueous solution and the method results in depolymerizing lignosulfonate or lignin which can be directly fed into a bioreactor for biological conversion.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

References cited herein are:
1. Davis, R., et al., Process design and economics for the conversion of lignocellulosic biomass to hydrocarbon fuels and coproducts: 2018 biochemical design case update. 2018, National Renewable Energy Laboratory.
2. Cao, L., et al., lignin valorization for the production of renewable chemicals: State-of-the-art review and future prospects. Bioresource Technology, 2018. 269: p. 465-475.
3. Sun, R.-C., J. S. M. Samec, and A. J. Ragauskas, Preface to special Issue of ChemSusChem on Lignin Valorization: From theory to practice. ChemSusChem, 2020. 13: p. 4175-4180.
4. Zakzeski, J., et al., The catalytic valorization of lignin for the production of renewable chemicals. Chemical Reviews, 2010. 110: p. 3552-3599.
5. Lange, H., S. Decina, and C. Crestini, Oxidative upgrade of lignin—Recent routes reviewed. European Polymer Journal, 2013.49: p. 1151-1173.
6. Ragauskas, A. J., et al., Lignin valorization: improving lignin processing in the biorefinery. Science, 2014. 344: p. 1246843.
7. Chen, Z. and C. Wan, Biological valorization strategies for converting lignin into fuels and chemicals. Renewable and Sustainable Energy Reviews, 2017. 73: p. 610-621.
8. Beckham, G. T., et al., Opportunities and challenges in biological lignin valorization. Current Opinion in Biotechnology, 2016. 42: p. 40-53.
9. Abdelaziz, O. Y., et al., Biological valorization of low molecular weight lignin. Biotechnology Advances, 2016.34: p. 1318-1346.
10. Salvachúa, D., et al. Production of renewable chemical building blocks from lignin by recombinant Pseudomonas putida KT2440 and further upgrading to polymers. in 40th Symposium on Biotechnology for Fuels and Chemicals. 2018. Clearwater Beach, Florida.
11. Rodriguez, A., et al., Base-catalyzed depolymerization of solid lignin-rich streams enables microbial conversion. ACS Sustainable Chemistry & Engineering, 2017. 5: p. 8171-8180.
12. Linger, J. G., et al., Lignin valorization through integrated biological funneling and chemical catalysis. Proc. Nat. Acad. Sci., 2014. 111: p. 12013-12018.
13. Lancefield, C. S., et al., Isolation of functionalized phenolic monomers through selective oxidation and C—O bond cleavage of the b-O-4 linkages in lignin. Angewandt Communications, 2015. 54: p. 258-262.
14. Shuai, L., et al., Formaldehyde stabilization facilitates lignin monomer production during biomass depolymerization. Science, 2016. 354: p. 329-333.
15. Picart, P., et al., Multi-step biocatalytic depolymerization of lignin. Appl Microbiol Biotechnol, 2017. 101: p. 6277-6287.
16. Rahimi, A., et al., Formic-acid-induced depolymerization of oxidized lignin to aromatics. Nature, 2014. 515: p. 249-252.
17. Sagues, W. J., et al., Lignin-first approach to biorefining: utilizing Fenton's reagent and supercritical ethanol for the production of phenolics an sugars. ACS Sustainable Chem. Eng., 2018. 6: p. 4958-4965.
18. Katahira, R., et al., Base-catalyzed depolymerization of biorefinery lignins. ACS Sustainable Chem. Eng., 2016. 4(3): p. 1474-1486.
19. Klinger, G. E., et al., Nucleophilic thiols reductively cleave ether linkages in lignin model polymers and lignin ChemSusChem, 2020. 13: p. 1-7.
20. Phongpreecha, T., et al., Predicting lignin depolymerization yields from quantifiable properties using fractionated biorefinery lignins. Green Chemistry, 2017. 19: p. 5131-5143.
21. Wang, S., et al., Unlocking structure-reactivity relationships for catalytic hydrogenolysis of lignin into phenolic monomers. ChemSusChem, 2020. 13: p. 4548-4556.
22. Song, Q., et al., Lignin depolymerization (LDP) in alcohol over nickel-based catalysts via a fragmentation-hydrogenolysis process. Energy & Environmental Science, 2013. 6: p. 994-1007.
23. Van den Bosch, S., et al., Reductive lignocellulose frationation into soluble lignin-derived phenolic monomers and dimers and processable carbohydrate pulps. Energy and Environmental Science, 2015. 8: p. 1748-1763.
24. Anderson, E. M., et al., Reductive catalytic fractionation of corn stover lignin. ACS Sustainable Chem. Eng., 2016. 4: p. 6940-6950.
25. Luo, H., et al., Total utilization of miscanthus biomass, lignin and carbohydrates, using earth abundant nickel catalyst. ACS Sustainable Chem. Eng., 2016. 4: p. 2316-2322.
26. Wang, H., M. Tucker, and Y. Ji, Recent development in chemical depolymerization of lignin: A review. Journal of Applied Chemistry, 2013. 2013: p. 1-9.
27. Deepa, A. K. and P. L. Dhepe, Lignin depolymerization into aromatic monomers over solid acid catalysts. ACS Catalysis, 2014. 5: p. 365-379.
28. Lan, W., et al., Protection group effects during a, g-diol lignin stabilization promote high-selectivity monomer production Angewandte Chemie Int. Ed., 2018. 57: p. 1356-1360.
29. Salvachúa, D., et al., Lignin depolymerization by fungal secretomes and a microbial sink. Green Chemistry, 2016. 18: p. 6046-6062.
30. Gasser, C. A., et al., Sequential lignin depolymerization by combination of biocatalytic and formic acid/formate treatment steps Appl Microbiol Biotechnol, 2017. 101: p. 2575-2588.
31. Hammel, K. E. and D. Cullen, Role of fungal peroxidases in biological ligninolysis. Current Opinion in Plant Biology, 2008. 11: p. 349-355.
32. Chan, J. C., M. Paice, and X. Zhang, Enzymatic oxidation of lignin: Challenges and barriers toward practical applications. ChemCatChem, 2020. 12: p. 401-425.
33. Chow, C.-F., et al., Combined chemical activation and fenton degradation to convert waste polyethylene into high-value fine chemicals Chem. Eur. J., 2016. 22: p. 9513-9518.
34. Feng, H.-M., et al., Photoassisted fenton degradation of polystyrene Environ. Sci. Technol., 2011. 45: p. 744-750.
35. Krueger, M. C., et al., Potential of wood-rotting fungi to attack polystyrene sulfonate and its depolymerisation by gloeophyllum trabeum via hydroquinone-driven fenton chemistry PLoS ONE, 2015. 10.
36. Areskogh, D. and G. Henriksson, Fenton's reaction: a simple and versatile method to structurally modify commercial lignosulphonates. Nordic Pulp and Paper Research Journal, 2011. 26: p. 90-98.
37. Yang, J. C., M. J. Jablonsky, and J. W. Mays, NMR and FT-IR studies of sulfonated styrene-based homopolymers and copolymers. Polymer, 2002. 43: p. 5125-5132.
38. De, R., H. Lee, and B. Das, Exploring the interactions in binary mixtures of polyelectrolytes: Influense of mixture composition, concentration, and temperature on counterion condensation. Journal of Molecular Liquids, 2018.251: p. 94-99.
39. Zundel, G., Chapter II Assignment of the IR bands, in Hydration and intermolecular interaction: Infrared investigations with polyelectrolyte membranes. 1970, Elsevier Science and Technology.
40. Max, J.-J. and C. Chapados, Infrared spectroscopy of aqueous carboxylic acids: malic acid. J. Phys. Chem. A, 2002. 106: p. 6452-6461.
41. Kalliola, A. V., T.; Liitia, T.; Tamminen, T., Alkali-O2 oxidized lignin—a bio-based concrete plasticizer. Industrial Crops and Products, 2015. 74: p. 150-157.
42. Rodriguéz-Lucena, P., J. J. Lucena, and L. Hernández-Apaolaza. Relationship between the structure of Fe-lignosulfonate coplexes determined by FTIR spectroscopy and their reduction by the leaf Fe reductase. in International Plant Nutrition Colloquium XVI. 2009. UC Davis: Department of Plant Sciences.
43. Boeriu, C., et al., Characterization of structure-dependent functional properties of lignin with infrared spectroscopy. Industrial Crops and Products, 2004. 20: p. 205-218.
44. Asgari, F. and D. S. Argyropoulos, Fundamentals of oxygen delignification. Part II. Functional group formation/elimination in residual kraft lignin. Can. J. Chem., 1998. 76: p. 1606-1615.
45. Zeng, J., et al., Biomimetic Fenton-catalysed lignin depolymerization to high-value aromatics and dicarboxylic acids. ChemSusChem, 2015. 8: p. 861-871.
46. Hildén, L., et al., Do the extracellular enzymes cellobiose dehydrogenase and manganese peroxidase form a pathwy in lignin biodegradation? FEBS Lett., 2000. 477: p. 79-83.
47. Arantes, V. B., C.; Milagres, A. M. F., Degradation and decolorization of a biodegradable-resistant polymeric dye by chelator-mediated Fenton reactions. Chemosphere, 2006. 63: p. 1764-1772.
48. Salgado, P., et al., The reactivity and reaction pathway of Fenton reactions driven by substituted 1,2-dihydroxybenzenes. Environmental Science & Technology, 2017. 51: p. 3687-3693.
49. Kent, M. S., et al., Efficient conversion of lignin into a water-soluble polymer by a chelator-mediated Fenton reaction: optimization of H2O2 use and performance as a dispersant. Green Chemistry, 2018. 20: p. 3024-3037.
50. Pryor, W. A., Oxy-radicals and related species. Ann. Rev. Physiol., 1986. 48: p. 657-667.
51. Barapatre, A., et al., In vitro evaluation of antioxidant and cytotoxic activities of lignin fractions extracted from Acacia nilotica. international Journal of Biological Macromolecules, 2016. 86: p. 443-453.
52. Contreras, D. R., J.; Freer, J.; Schwederski, B.; Kaim, W., Enhanced hydroxyl radical production by dihydroxybenzene-driven Fenton reactions: implications for wood biodegradation. J Biol Inorg Chem, 2007. 12: p. 1055-1061.
53. Arantes, V. M., A. M. F., The effect of a catecholate chelator as a redox agent in Fenton-based reactions on degradation of lignin-model substrates and on COD removal from effluent of an ECF kraft pulp mill. Journal of Hazardous Materials, 2007. 141: p. 273-279.
54. Aguiar, A. and A. Ferraz, Fe³⁺ and Cu²⁺-reduction by phenol derivatives associated with Azure B degradation in Fenton-like reactions. Chemosphere, 2007. 66: p. 947-954.
55. Arantes, V., J. Jellison, and B. Goodell, Peculiarities of brown-rot fungi and biochemical Fenton reaction with regard to their potential s a model for bioprocessing biomass. Appl Microbiol Biotechnol, 2012. 94: p. 323-338.
56. Arantes, V., et al., Lignocellulosic polysaccharides and lignin degradation by wood decay fungi: the relevance of nonenzymatic Fenton-based reactions. J Ind Microbiol Biotechnol, 2011. 38: p. 541-555.
57. Melin, V., et al., Reduction reactivity of catecholamines and their ability to promote a Fenton reaction. Inorganic Chimica Acta, 2016. 453: p. 1-7.
58. Pieken, W. A. and J. W. Kozarich, lactonization of cis, cis-3-halomuconates: influence of pH and halo substituent on the regiochemistry. J. Org. Chem., 1990. 55: p. 3029-3035.

All patents, patent applications, and publications mentioned herein are hereby incorporated by reference in their entireties.

The invention having been described, the following examples are offered to illustrate the subject invention by way of illustration, not by way of limitation.

### Example 1

### Depolymerization of Lignin for Biological Conversion Through Sulfonation and a Chelator-Mediated Fenton Reaction

Generating value from lignin through depolymerization and biological conversion to valuable fuels, chemicals, or intermediates has great promise but is limited by several factors including lack of cost-effective depolymerization methods, toxicity within the breakdown products, and low bioconversion of the breakdown products. High yield depolymerization of natural lignins requires cleaving carbon-carbon bonds. Herein is reported a chelator-mediated Fenton reaction can efficiently cleave C—C bonds at or near room temperature in sulfonated polymers and that repolymerization can be minimized through control of the reaction conditions. This method is used to depolymerize lignosulfonate from Mw=28,000 g/mol to Mw=800 g/mol. The breakdown products are characterized by FTIR, NMR, and GC-MS and evaluated for bioavailability. The breakdown products are rich in acid, aldehyde, ether, and alcohol functionality but largely devoid of aromaticity. A panel of monocultures is tested for growth on the breakdown products. Growth at a low level is observed for several monocultures on the depolymerized LS in absence of glucose. Much stronger growth is observed in the presence of 0.2% glucose. These results suggest that this method may be promising for biological conversion of lignin into higher value chemicals or intermediates.

Toward that goal, herein is reported an alternative method to efficiently cleave C—C bonds and depolymerize lignins at or near room temperature. The method combines sulfonation with a chelator-mediated Fenton (CMF) reaction. Prior work has shown that the Fenton reaction can depolymerize sulfonated polyethylene [33], sulfonated polystyrene [34, 35], and lignosulfonate (LS) [36]. In the latter case the emphasis is on increasing the molecular weight of LS for polymeric applications, in contrast to the aim of the present work, but that work also showed that depolymerization occurs for some reaction conditions. Herein the focus is on optimizing CMF for depolymerization of lignins. While interest in this work is valorizing lignin, herein is reported the depolymerization of polystyrene sulfonate (PSS) because i) PSS has only C—C bonds in the backbone and therefore depolymerization unambiguously occurs through C—C bond cleavage, ii) the narrow molecular weight distribution of PSS standards facilitates establishing trends with reaction conditions, and iii) comparison between results for PSS and LS provides important insights into reaction mechanisms. Herein is reported trends in the molecular weight distribution with reaction conditions and show that repolymerization can be minimized through control of reagent concentrations and reaction temperature. Then it is reported depolymerization of LS. It is reported similar trends in the molecular weight distribution with reaction conditions as for PSS. It is shown that LS repolymerization can be minimized through control of reagent concentrations and reaction temperature. This depolymerization approach involving hydroxyl radical is non selective [5], and generates a broad distribution of products. Herein is reported that the LS depolymerization products are rich in acid, alcohol, ether and alcohol functionalities but are devoid of aromaticity. In anticipation of a biological conversion approach to upgrade the breakdown products, it is reported initial studies of growth of a panel of microorganisms on the LS breakdown stream.

### EXPERIMENTAL

### Materials

Polystyrene sulfonate standards are obtained from Scientific Polymer Products (Mw=5,600 g/mol, PDI 1.02 and 5,200 g/mol, PDI 1.13) and Polymer Standards Service (63,900, PDI<1.2). Lignosulfonate DP-4397 is a gift from Borregaard. FeCl3 heptahydrate and Fe₂(SO₄)₃ and DHB from Aldrich. H₂O₂ (33-37%) from Fisher.

Depolymerization of Polystyrene Sulfonate and Lignosulfonate with CMF

### Growth Studies

The microbial strains used for single-organism cultivations in this study can be accessed at the Joint BioEnergy Institute public registry (the webpage of: public-registry.jbei.org) with the following names and accession numbers: Corynebacterium glutamicum (need to get JPUB numbers), Rhodococcus rhodochrous, Exophiala alcalophila, Delftia acidovorans, Pseudomonas putida, Rhodococcus jostii, Bacillus subtilis, Bacillus amyloliquefaciens, and Rhodosporidium toruloides.

Tryptic soy broth (Sigma-Aldrich) is prepared as 30 g/L in water and autoclaved at 121° C. for 20 minutes. A 10× yeast nitrogen base medium without amino acids (SIGMA-Aldrich) is prepared according to the manufacturer's specifications and supplemented with Complete Supplement Mixture (MP Biomedicals, USA) at a final concentration of 80 mg/L. The pH of the resulting medium (YNB+CSM) is adjusted to a value of 6 with 10 N NaOH and the solution is filter sterilized (0.45 μm cellulose-acetate membrane). The depolymerized lignosulfonate material at a concentration of 5 mg/mL is also filtered (0.45 μm cellulose-acetate membrane), mixed at a 9:1 v/v ratio with the 10×YNB+CSM stock solution, and used for microbial cultivations.

To start the cultivations, all organisms are inoculated from agar plates and grown for 24 hours in tryptic soy broth at 30° C. The cells are then centrifuged, resuspended in water, and transferred at an initial OD of approximately 0.1 to 1 to 48-well plates containing cultivation medium (500 μL final volume per reaction). The reactions are performed by triplicate. The plates are covered with an AeraSeal sealing film (Excel Scientific, USA) and a plastic lid to prevent evaporation and incubated at 30° C. with shaking at 300 rpm for 60 h. Cell density is determined by measuring absorbance at 600 nm with a plate reader (Tecan Spark, Switzerland). At the end of the cultivations, the plates are briefly centrifuged, and the supernatants are filtered using 0.45 μm centrifuge filters and kept at −20° C. until analysis.

### Results

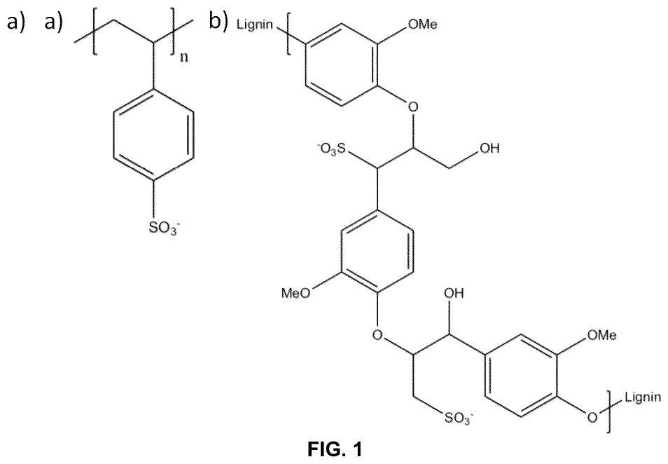

The chemical structures of PSS and LS are given in FIG. 1. For PSS, a sulfonic acid group exists at the para position of the aromatic ring whereas in lignosulfonate the sulfonic acid groups are on the alpha or gamma carbons of the aliphatic chain adjacent to the aromatic ring.

### Depolymerization of PSS

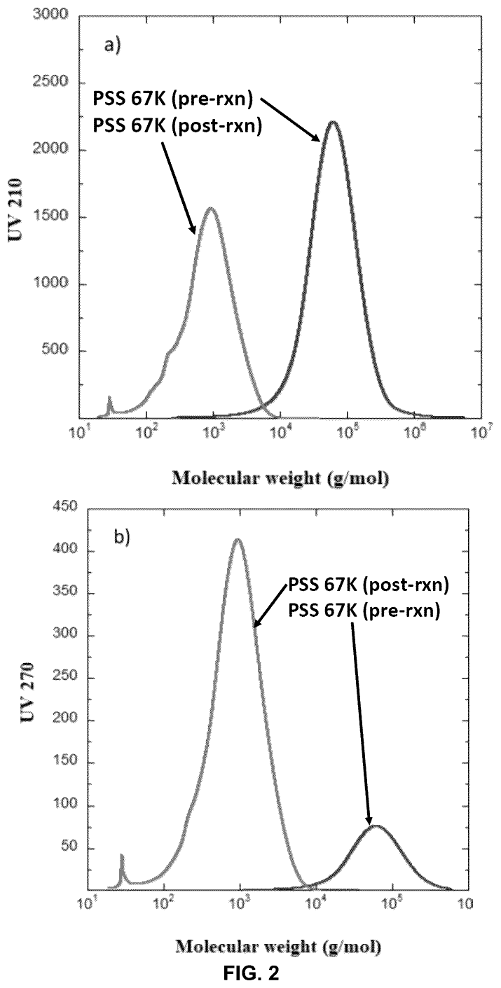

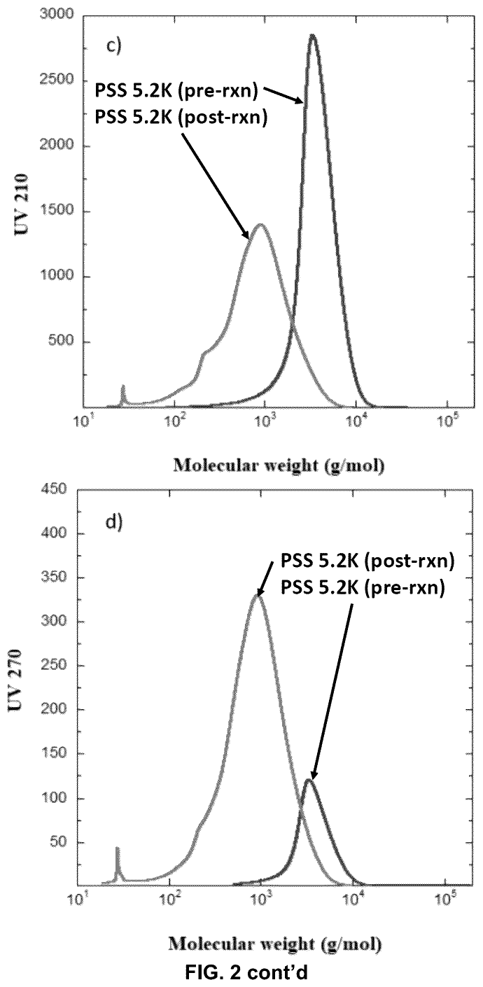

FIG. 2 shows the decrease in molecular weight for PSS 67K and PSS 5K for CMF reactions with [FeCl3]=[DHB]=1 mM, and [H₂O₂]=0.5% at room temperature (RT) using UV detection at 210 nm and 270 nm. The weight averaged molecular weight (Mw) decreases by a factor of 75 for PSS 67K (from 75,000 g/mol to 1,000 g/mol) and by a factor of 4.4 for PSS 5K (UV 210). For both samples, the final Mw is comparable at ˜1000 g/mol which suggests that careful optimization of conditions will be required to depolymerize to lower M_{w}. At 210 nm the UV signal of the post reaction material is decreased relative to the unreacted material whereas at 270 nm the UV signal increases upon reaction. The latter indicates an increase in conjugation within the structures after reaction.

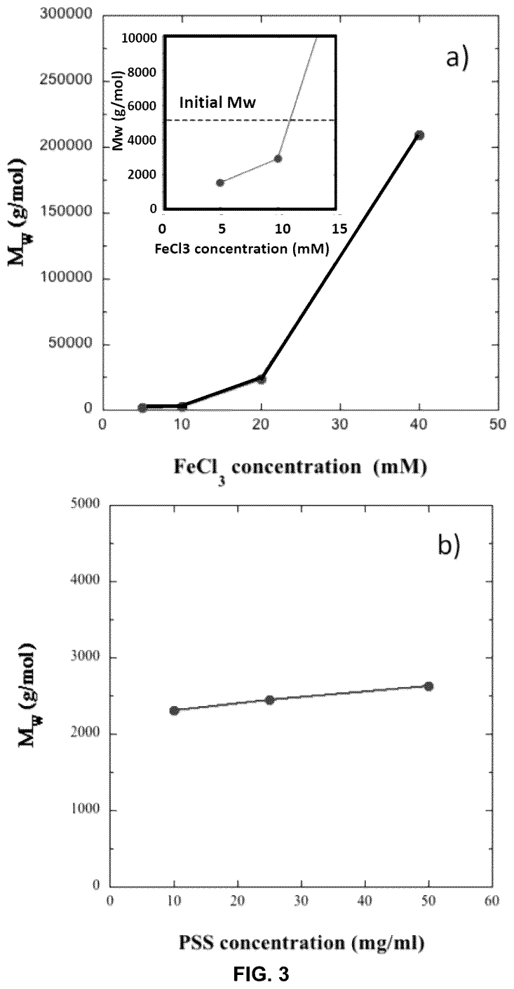

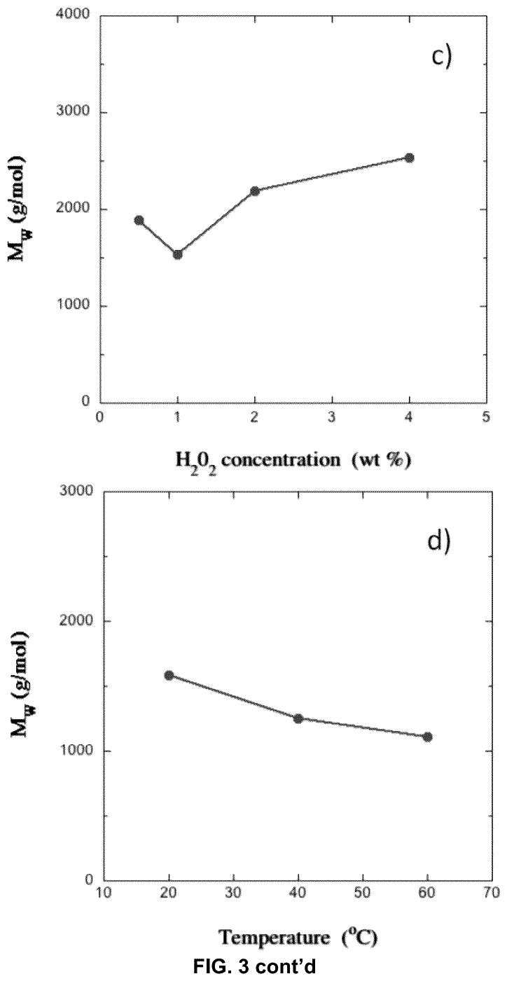

Toward the goal of optimizing CMF for depolymerization, the dependencies of M_{w} on various reaction conditions are determined. FIG. 3 shows changes in post-reaction M_{w} for CMF reactions with PSS5.2K as a function of [FeCl₃], [PSS], [H₂O₂], and temperature. By far the strongest impact on M_{w} occurs with [FeCl₃], with M_{w} increasing strongly with [FeCl₃] (FIG. 3 (Panel a). Depending on [FeCl₃], M_{w} values greater or less than that of the initial sample can be obtained (FIG. 3 (Panel a). These results suggest that both C—C bond cleavage and repolymerization occur, and that repolymerization is minimized at lower [FeCl₃]. The inset to FIG. 3 (Panel a) shows that for the final Mw is lower than the initial value for [FeCl₃]<11 mM for these conditions.

FIG. 3 (Panel b) shows that Mw also increases with [PSS], albeit with a much weaker dependence, suggesting that repolymerization is also minimized at lower [PSS]. The trend with [H₂O₂] is more complex. Mw decreases with decreasing [H₂O₂] above 1 mM, again indicating less repolymerization occurs at lower reaction severity. However, Mw increases for [H₂O₂]<1%. We suggest that below 1% the amount of H₂O₂ is limiting for these reaction conditions and the number of C—C bonds cleaved diminishes. For [H₂O₂]>1% more C—C bond cleavage occurs but with increasing repolymerization with increasing [H₂O₂]. Finally, FIG. 3 (Panel d) shows that Mw decreases slightly with increasing T.

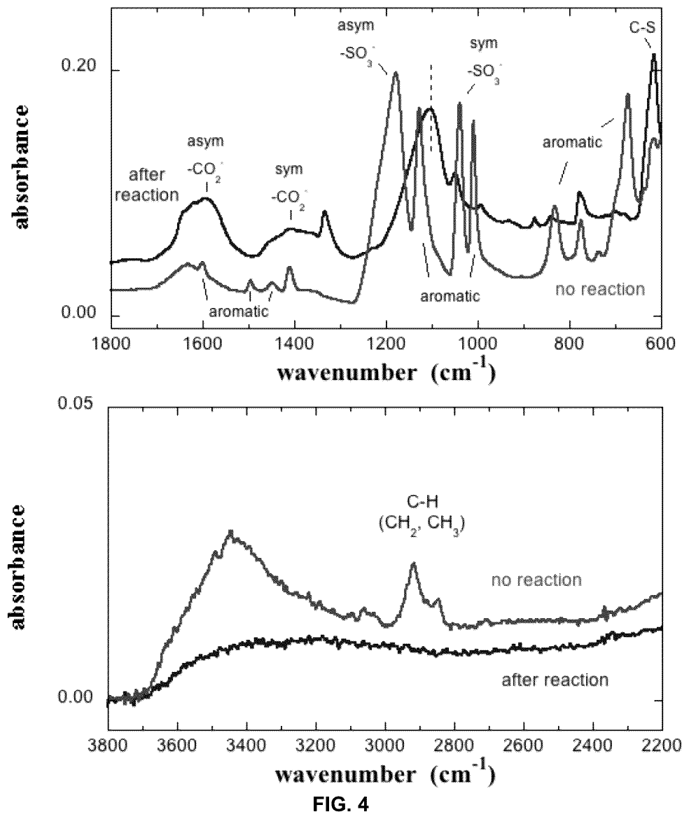

FIG. 4 shows the FTIR spectrum for depolymerized PSS products ([H₂O₂]=1%, [FeCl₃]=[DHB]=1 mM, RT) measured in attenuated total reflection after depositing the post reaction solution onto a substrate and drying in vacuum. The spectrum of unreacted PSS is also shown for comparison. Band assignments for PSS are made following prior work [37-39]. For PSS strong absorbance bands at 1184 cm⁻¹ and 1042 cm⁻¹ correspond to the SO₃⁻ asymmetric and symmetric stretch vibrations, respectively, and bands at 1130 cm⁻¹ and 1010 cm⁻¹ correspond to the in-plane skeletal vibration and in-plane bending vibrations, respectively, of the substituted benzene ring. The band at 833 cm⁻¹ is due to CH out-of-plane vibration for para disubstituted benzene. The band at 672 cm⁻¹ is due to aromatic ring vibration involving C—S stretching. Weaker aromatic skeletal vibrations are present at 1598 cm⁻¹, 1514 cm⁻¹, and 1425 cm⁻¹ in unreacted PSS. The band at 1460 cm⁻¹ is assigned to C—H deformation combined with aromatic ring vibration. Bands at 2800-3000 cm⁻¹ are due to C—H stretch of methyl and methylene groups. In the post-reaction spectrum the aromatic bands are almost completely absent. The broad band centered at 1600 cm⁻¹ in the post-reaction sample is attributed to the asymmetric stretch of a carboxylate anion that is associated with Fe. Whereas free carbonyl occurs at 1700-1720 cm⁻¹, the band shifts to 1600 cm⁻¹ upon association with a cation in a dried salt, as shown in prior study of malic acid and sodium malate [40]. The broad band centered at 1400 cm⁻¹ in the post-reaction sample is attributed to the symmetric carboxylate C—O vibration [40]. Bands at 2800-3000 cm⁻¹ due to C—H stretch of methyl and methylene groups are absent in the post reaction sample. Methylene groups are present in the backbone of PSS, and their absence in the post-reaction sample is consistent with extensive oxidative and/or cleavage of backbone C—C bonds. The strong band at 1100 cm⁻¹ in the post-reaction sample is tentatively assigned to C—O stretch of tertiary alcohols, esters, or aliphatic ethers generated upon oxidative cleavage of C—C bonds.

### Depolymerization of LS

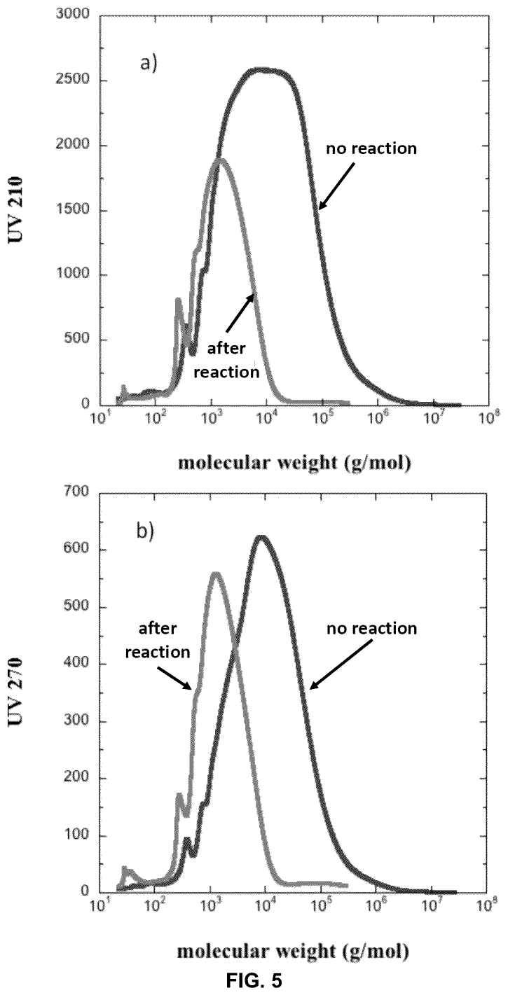

FIG. 5 displays the decrease in molecular weight for CMF reactions of LS with [FeCl₃]=[DHB]=0.5 mM, and [H₂O₂]=0.5% at 22° C. using UV detection at 210 nm and 270 nm. M_{w} decreased by a factor of >8 (from 28,000 g/mol to 3400 g/mol, UV 210 nm). The UV signals at 210 nm and 270 nm both decrease upon reaction, however at 270 nm the decrease is weaker. The latter indicates only a small decrease in conjugation within the structures after reaction.

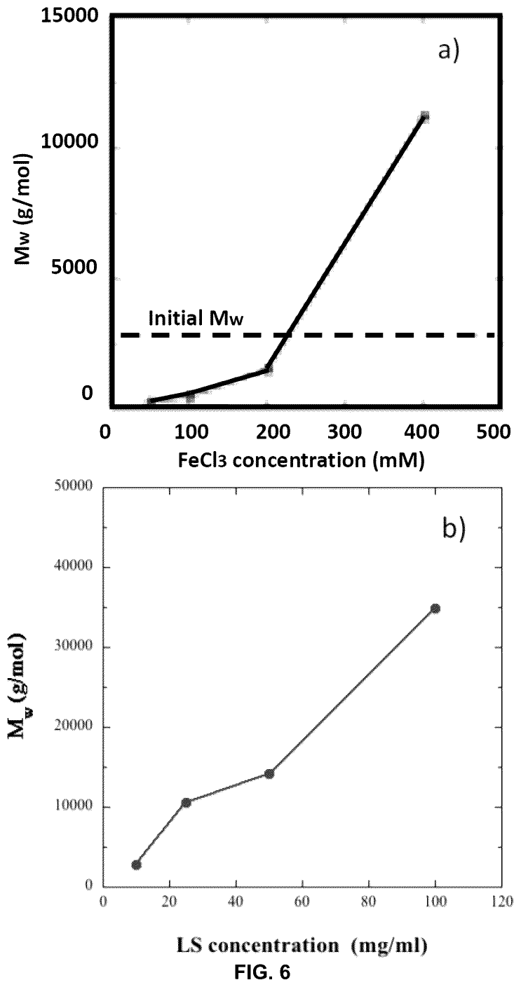

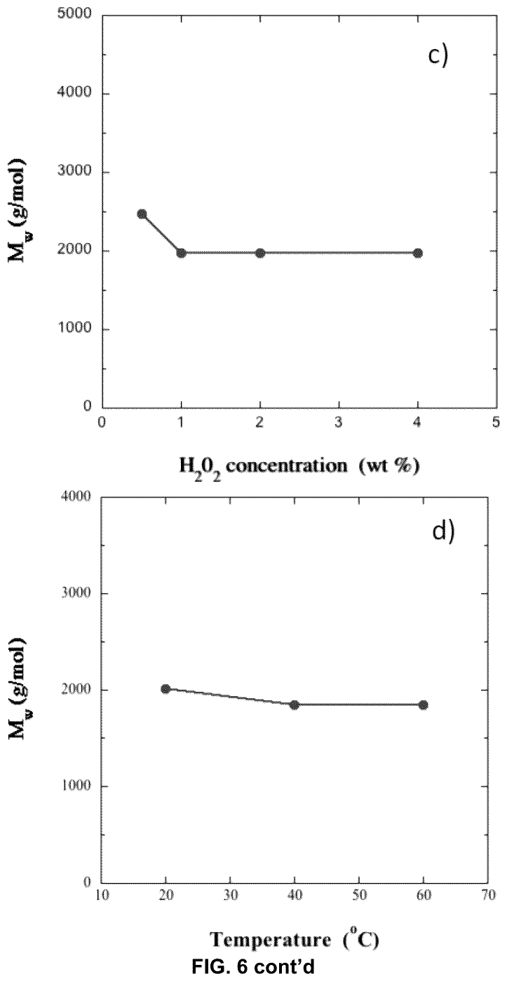

FIG. 6 shows the variation in post-reaction M_{w} for CMF reactions with LS as a function of [FeCl₃], [LS], [H₂O₂], and temperature. As for PSS, by far the strongest effect on M_{w} occurs with [FeCl₃], with M_{w} increasing strongly with [FeCl₃] (FIG. 6 (Panel a)). The results show that M_{w} can be increased or decreased substantially depending on [FeCl₃]. FIG. 6 (Panel b) shows that M_{w} also increases with [LS], suggesting that repolymerization is minimized at lower [LS]. The trend of increasing M_{w} with [LS] is consistent with prior reports for the Fenton reaction with LS [36] and for alkali-O2 oxidation of soda lignin [41]. FIG. 6 (Panel c) shows that very little change in M_{w} occurs with [H₂O₂] from 1% to 4%, but at 0.5% M_{w} is increased. As for the PSS reactions, it is suggested that the amount of H₂O₂ is limiting at 0.5% resulting in a decrease in the number of C—C bonds cleaved. FIG. 6 (Panel d) shows that M_{w} decreases slightly with increasing T. While the effects of [LS], [H₂O₂], and T are weaker than for [FeCl₃], they are important for achieving the lowest possible M_{w} by minimizing repolymerization.

Whereas the present work is focused on depolymerization, it is noted that increasing the molecular weight of LS is important for certain polymer applications, such as its use as a concrete plasticizer [36, 41]. FIG. 6 (Panel a) shows that CMF at high [Fe] is a highly effective route to increase M_{w}. Iron is a relatively low-cost reagent, especially in the form of iron sulfate which can be used in place of FeCl₃ in the CMF reaction.

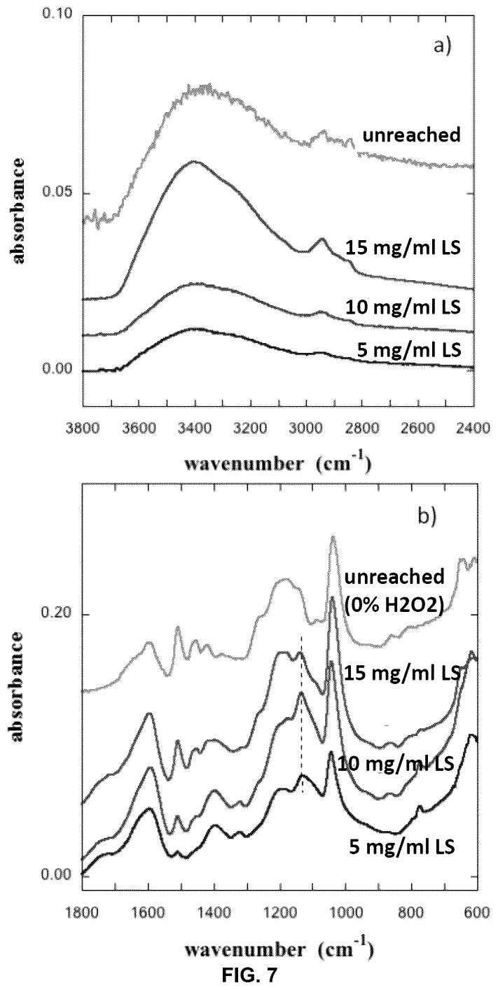

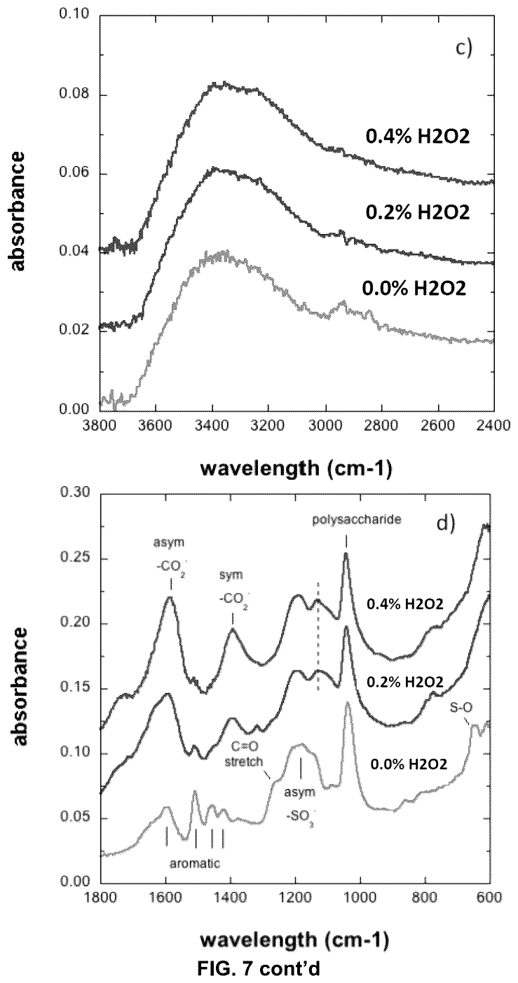

FTIR spectra are given in FIG. 7 (Panels a and b) for LS depolymerization products from a series of reactions conducted as a function of [LS] (a and b), and as a function of [H₂O₂](c and d). The spectrum of unreacted LS is also shown for comparison. Band assignments for LS are made based on prior work [42, 43]. Bands at 2800-3000 cm⁻¹, 1540 cm⁻¹, 1460 cm⁻¹, and 1420 cm⁻¹ are assigned as for PSS. The band at 1050 cm⁻¹, which is largely unaffected by the CMF reaction, is assigned to polysaccharide (C—O and C—C stretching and C—OH bending). The band at 1260 cm⁻¹ is assigned to guaiacyl ring vibration. The broad band at 1190 cm⁻¹ is assigned to the SO₃⁻ asymmetric stretch vibration. The SO₃⁻ symmetric stretch vibration expected at 1040 cm⁻¹ apparently overlaps with the polysaccharide band. The band at 640 cm⁻¹ is assigned to S—O stretch of the sulfonic acid groups. As in the case of CMF reactions with PSS, for LS the aromatic vibrations at 1514 cm⁻¹, 1469 cm⁻¹, and 1420 cm⁻¹ in unreacted LS are reduced substantially in the post-reaction spectrum and strong bands from symmetric and asymmetric stretch of carboxylate anion centered at 1600 cm⁻¹ and at 1400 cm⁻¹ are present in the post-reaction spectra. Bands at 2800-3000 cm⁻¹ for unreacted LS due to C—H stretch of methyl and methylene groups are reduced in the post reaction spectra. Methoxy groups in LS are the likely source of these bands. Their absence in the post-reaction sample is consistent with oxidation of methoxy groups to generate methanol which would be lost during sample drying. Oxidation of methoxy groups to generate methanol has been reported previously for oxidative treatments of lignin [44-46]. A band at 1130-1135 cm⁻¹ is present in the post reaction spectra, which is not present in unreacted LS, which we tentatively assign that to the C—O stretch of secondary or tertiary alcohols or of aliphatic ethers generated upon oxidative cleavage of C—C bonds.

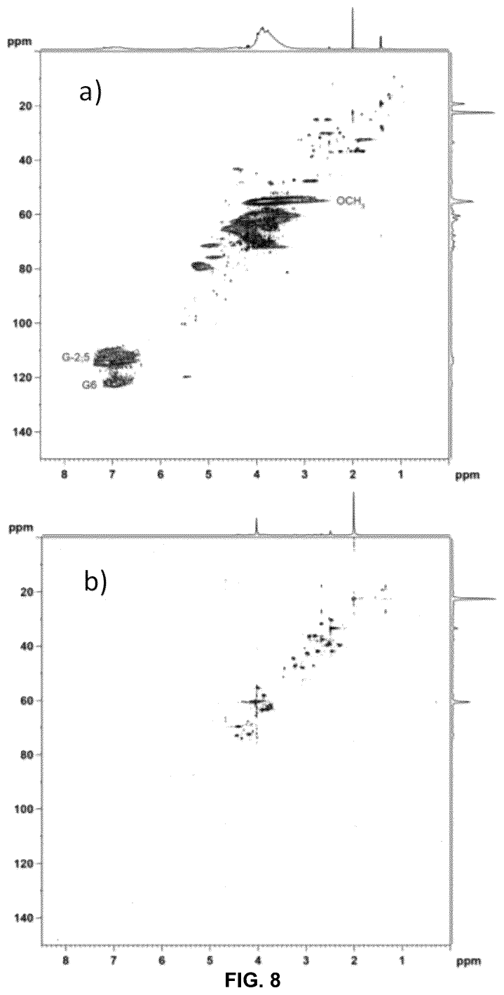

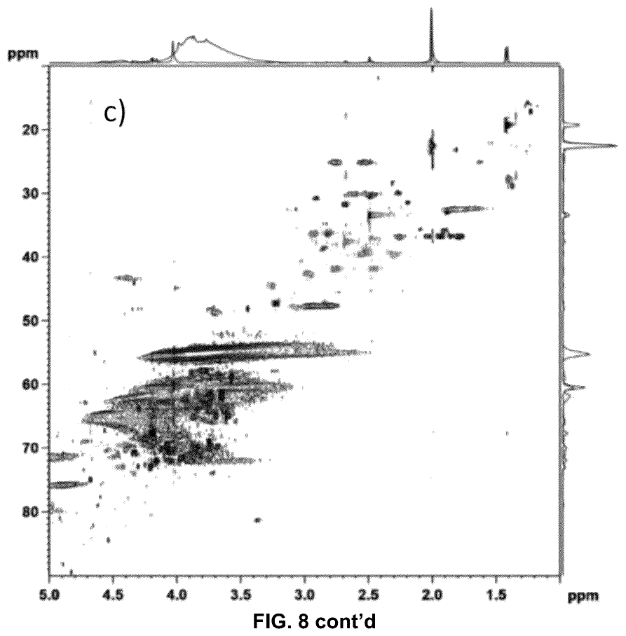

Two-dimensional ¹H-¹³C HSQC NMR spectra for LS before and after CMF reaction is shown in FIG. 8. For the post-reaction sample the aromatic region is entirely devoid of signals. The aliphatic region of the spectrum indicates that the methoxy groups are no longer present.

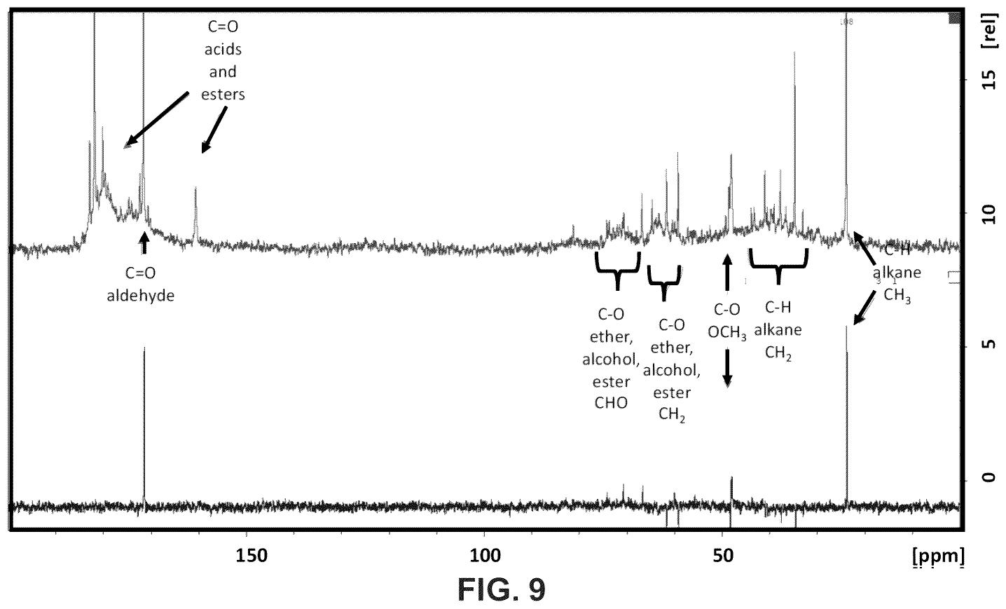

Quantitative ¹³C NMR and Insensitive Nuclei Enhancement by Polarization Transfer (INEPT) NMR spectra are given in FIG. 9. Integration of the ¹³C NMR spectra over the ranges 200 to 155 ppm (carbonyls), 150-100 ppm (aromatics and alkenes), and 90-20 ppm (ethers, alcohols, esters, and alkanes) indicates that ˜46% of the carbon atoms are carbonyls, about 4% are aromatic C or dienes, and 20% (Todd—give actual value) are carbons bonded to oxygen and 30% (Todd—give actual value) are alkanes. The INEPT spectrum indicates whether the number of protons bonded to each C environment is odd (positive) or even (negative). This shows that the signal at 171.6 ppm is due to aldehyde. Integration of that region in the ¹³C spectrum indicates that about 10-15% (Todd what is the real number) of the C are aldehydes.

To identify some of the major depolymerization products, a sample is lyophilized, extracted in MeOH, and then analyzed by GC-MS. Over 90% by mass of the sample dissolved in MeOH. GC-MS data are shown in FIG. 9.

To estimate the amount of material lost as CO₂ or other low molecular weight volatile species during the CMF reaction samples of the post-reaction solution are freeze-dried and then weighed and compared to the total mass of LS, DHB, and FeCl₃ added to the reaction mixture. For comparison, LS is dissolved in water and then freeze-dried and weighed in the same manner. For unreacted LS, the mass recovered after freeze-drying is 89+/−3% and for the post CMF reaction samples ([LS]=5 mg/ml, [FeCl3]=[DHB]=0.5 mM, [H₂O₂]=0.5%, at 40° C.) the mass recovered after freeze-drying is 91+/−3%. This suggests that the mass of carbon lost as CO₂ is small. However, a precise estimate is not possible by this method since the mass of oxygen added to the LS breakdown products during the CMF reaction is unknown. Total organic carbon (TOC) measurements are also performed for products of reactions with varying [H₂O₂] for [LS]=5 mg/ml, [FeCl₃]=[DHB]=0.5 mM at 40° C. The results indicate <20% loss of TOC at [H₂O₂]=0.5%.

### Growth of Organisms on the Products of LS Depolymerization

For an initial evaluation of the bioavailability of the products of CMF depolymerization of LS the growth of a panel of microorganisms on the LS depolymerization products alone and also with 0.2% glucose is measured. For these assays 5 g of LS in 1 liter is depolymerized using the following conditions and protocol. Mw of resultant depolymerized material is 780 g/mol.

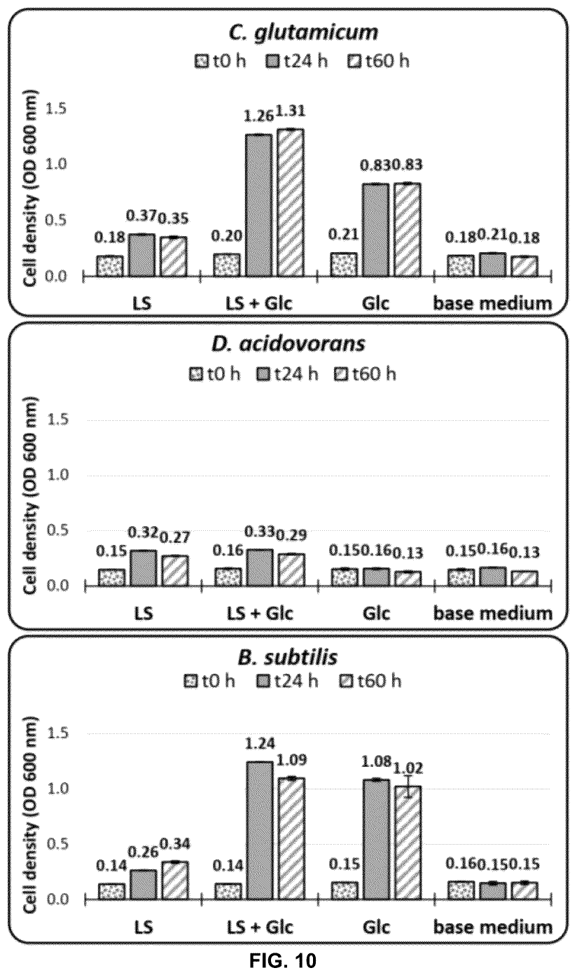

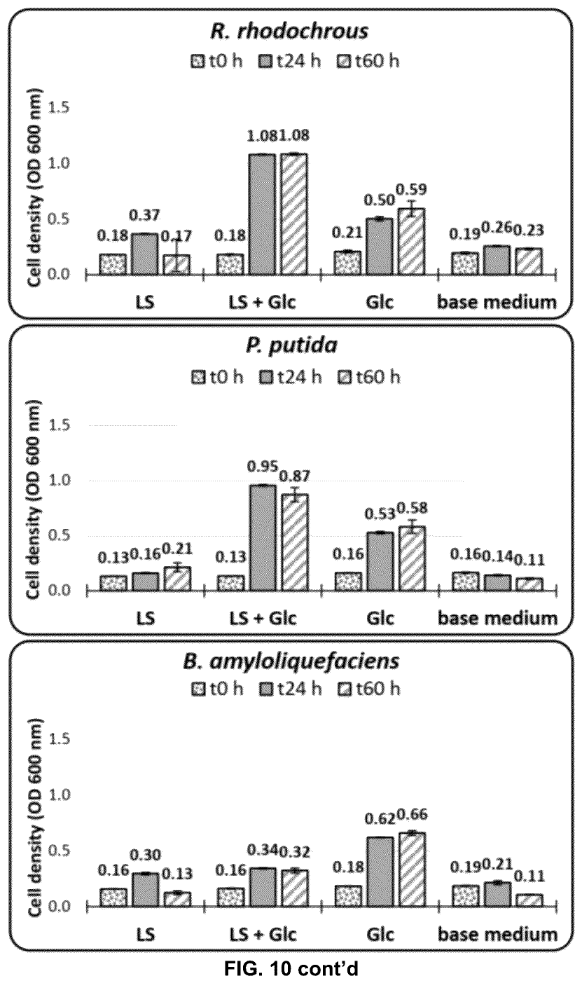

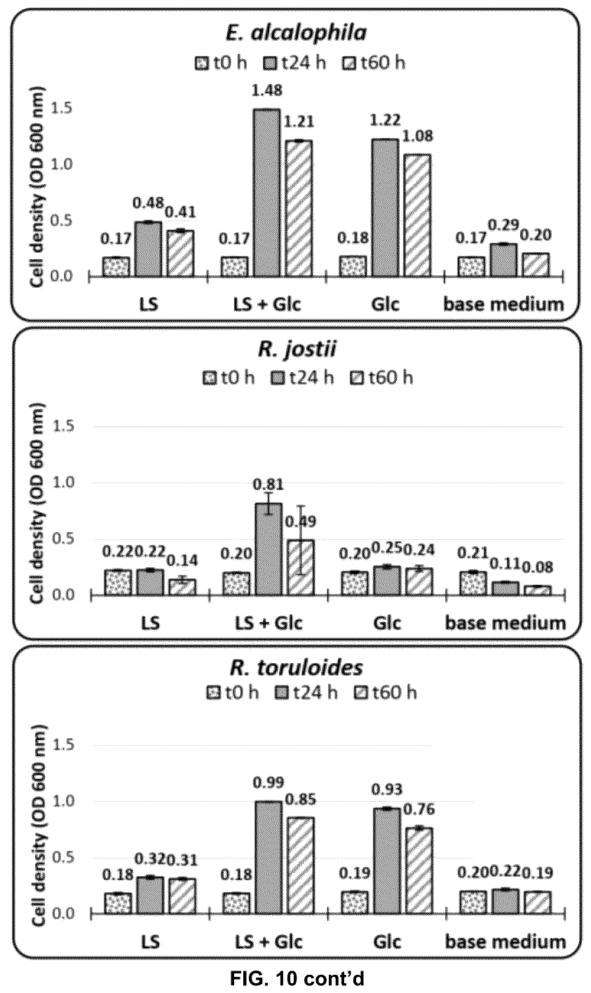

FIG. 10 shows OD600 for monocultures of the panel of microorganisms in microtiter plates growing on 5 mg/mL LS depolymerization products alone and supplemented with 0.2% glucose. Also shown are the OD600 values obtained for 0.2% glucose alone and for the base medium (YNB+CSM) that is added to all conditions. The results show that several organisms can grow on the LS material, alone or in combination with glucose. These reach maximum cell density within 24 h. However, different growth profiles are observed. For example, the simultaneous presence of LS and glucose resulted in an additive effect in E. alcalophila, and B. subtilis and R. toruloides, while a synergistic effect (higher OD than the sum of the values obtained with only LS or glucose) is observed with C. glutamicum, R. rhodochrous, P. putida and R. jostii. Growth with only LS is modest but reproducible, indicating that some components in the depolymerized stream can be consumed. The substantial growth with LS+glucose suggests that the LS material imposes low toxicity to these organisms and that there may be compounds in the breakdown stream that can be assimilated but cannot sustain growth without an additional carbon or energy source such as Glc. Other interesting effects are observed with D. acidovorans, which is known to be unable to metabolize Glc, and R. jostii, which could only grow in presence of both LS and Glc.

### Discussion

Cleaving C—C bonds generally requires high temperatures. On the other hand, specific enzymes such as perform this feat at room temperature by creating a local environment that drastically lowers the energy barrier for bond cleavage. Nonspecific oxidative enzymes also cleave C—C bonds at ambient conditions, but the process is very inefficient. Herein is reported a method to cleave C—C bonds efficiently in polymers containing sulfonic acid groups at or near room temperature. Depolymerization of PSS by CMF shows unambiguously that C—C backbone bonds are cleaved efficiently under mild conditions using this method. Prior work has demonstrated depolymerization of sulfonated PE, PSS, and LS by Fenton reactions [33-36]. In the present work it is shown the depolymerization also proceeds efficiently with CMF. In the CMF reaction, the iron chelator DHB reduces Fe³⁺ to Fe²⁺ and therefore promotes multiple cycles of the reaction of Fe²⁺ with H₂O₂ [47, 48]. At low reaction severity depolymerization occurs for both PSS and LS, and the trends in Mw with reaction conditions are similar for the two sulfonated polymers despite the fact that the chemical structures of these polymers differ greatly. In particular, the location of sulfonation is entirely different in LS and PSS, with sulfonation occurring on aromatic rings in PSS and on aliphatic OH groups in LS. Sulfonation is a requirement for efficient C—C bond cleavage by CMF, as CMF reaction with lignin in absence of sulfonation results in aromatic ring opening but little decrease in molecular weight for these conditions [49]. Aromaticity is not required for C—C bond cleavage in sulfonated polymers by the Fenton reaction, as sulfonated polyethylene can also be depolymerized with this method [33]. Based on the above it is proposed that the positively charged Fe ions, alone or in complex with DHB, associate strongly with negatively-charged sulfonic acid groups such that hydroxyl radical is generated in very close proximity to the polymer chain. Hydroxyl radicals are highly reactive and are believed to react within 1-5 molecular diameters of their site of formation in the crowded environment of living cells [50]. Generating hydroxyl radical in close proximity to the lignin chain greatly increases the probability of a productive reaction.

The strength of the sulfonic acid group seems to be critical for effective C—C bond cleavage using CMF. Lignin (absent sulfonation) is known to chelate Fe [45, 51], however despite that fact the CMF reaction does not lead to extensive depolymerization. Extensive opening of aromatic rings occurs but only a small amount of low molecular weight material is generated [49]. It is proposed that the efficient and extensive C—C bond cleavage for CMF with polymers functionalized with SO₃H is due to the strong electrostatic interactions between Fe with acid groups that occurs in the pH range>3, generating intensive interactions of hydroxyl radical with the polymer chains.

The role of DHB in the CMF reactions reported here is somewhat enigmatic. Since the reaction of Fe(III) with H₂O₂ is 3 orders of magnitude slower than that of Fe(II) with H₂O₂ [48], Fe chelators such as DHB that efficiently reduce Fe(III) to Fe(II) have been used [52-54], motivated by the mechanism of brown rot fungi to degrade wood [55, 56]. The coordination number of complexes of Fe and DHB is pH dependent, and only monocomplexes can reduce Fe(III) [48, 57]. Whereas the rate of the Fenton reaction is greatest at low pH (2-3), the use of DHB or other Fe-chelators increases the pH range for reactivity of Fenton systems to pH>5 [47, 48, 53, 57]. Catecholates have been reported to reduce 5-6 moles of Fe(III) per mole of chelator [47]. Most of the CMF reactions in the present work involved 0.5% H₂O₂ (147 mM) to 1% H₂O₂ (294 mM). Since DHB is added at only 4 mM (FIG. 3 and FIG. 6), this amount of H₂O₂ consumed is much greater than can be accounted for if H₂O₂ reacts only with Fe(II) and if Fe(III) is only reduced to Fe(II) by DHB. Either a substantial fraction of the H₂O₂ is reacting directly with LS in absence of Fe, or LS (and PSS) has substantial Fe(III)-reducing capability. Little H₂O₂ consumption is detected in control reactions in absence of Fe, therefore it is concluded that oxidized LS and oxidized PSS have substantial Fe(III)-reducing capability, in agreement with prior work [45]. It is concluded that a small amount of DHB is needed for initial oxidation of LS, but that after initial mild oxidation of LS the majority of the H₂O₂ is consumed due to Fe(III)-reducing power of oxidized LS. This favorable circumstance greatly reduces the requirement for DHB to depolymerize LS.

The data also show that repolymerization occurs with increasing reaction intensity (higher [FeCl₃] and [H₂O₂]) and with increasing concentration of LS. Higher reaction intensity will result in a greater density of lignin fragments that contain radicals, and therefore increasing the prevalence of condensation reactions. With increasing concentration of LS, the probability of lignin fragments containing radicals coming into contact before the radicals dissipate will increase.

Abdelaziz et al. recently reported oxidative depolymerization of LS using heterogeneous catalysts at elevated T and P [9], which invites comparisons with the present approach. Regarding the extent of depolymerization, they reported a shift from a very broad distribution with peak molecular weight (Mₚ)˜3000 to a much narrower distribution with Mₚ=1400 Da (UV detection at 280 nm). In the present work FIG. 5 (Panel b) shows a shift from Mₚ=9000 Da to Mₚ=1300 Da and the lowest Mₚ achieved in the present work for this LS sample is 800 Da. This comparison suggests that repolymerization may be more readily minimized using the present method. The products reported by Abdelaziz et al. were mostly de-aromatized and there was a strong loss of methoxy groups, as shown by ¹H-¹³C HSQC NMR. These characteristics are also observed for the present work. Abdelaziz et al. also reported the low molecular weight products methanol, formaldehyde, formic acid, acetaldehyde, and acetic acid. Larger compounds included polyhydroxylated carbonyl-containing compounds such as β-hydroxy-γ-butyrolactone and the β-sulphonate derivative of γ-butyrolactone. Despite the fact that the aromatic signal in ¹H-¹³C HSQC NMR is strongly decreased, the aromatic monomers vanillin, p-hydroxybenzaldehyde, vanillic acid, and p-benzoic acid are detected by supercritical fluid chromatography mass spectrometry following extraction with ethyl acetate and subsequent concentration. Lactones were not identified as major components of the breakdown stream in the present work, in contrast to the catalytic processes of Abdelaziz et al. Opening of aromatic rings should lead to muconic acid structures and these form lactones via ring closure for neutral or acidic conditions [41, 58].

Most prior work on biological conversion of lignin has focused on releasing aromatic monomers and dimers from lignins and utilizing conversion hosts with suitable native or engineered metabolic pathways to convert the aromatic compounds into useful chemicals or intermediates [7-12]. This is motivated by natural processes of lignin depolymerization and utilization in the environment. While this occurs very slowly in nature, as an industrial process this approach is most promising for engineered lignins that contain a very high content of ether bonds [14]. For natural lignins this approach has had limited success due to several factors including low yield of aromatic monomers, toxicity of some of the aromatic breakdown products, and the tendency for polymerization to occur simultaneous with depolymerization. The yield of aromatic monomers is fundamentally limited by the presence of C—C bonds.

In this work an alternative, or perhaps complementary, approach is introduced. It is shown that CMF reaction with sulfonated lignin cleaves C—C bonds efficiently at or near room temperature at ambient pressure. It is also shown that under suitable conditions repolymerization can be minimized. However, these reaction conditions also open the aromatic rings and the breakdown products consist of low molecular weight species rich in acid, aldehyde, ether and alcohol groups. It remains to be seen whether conversion hosts can be found, evolved, or engineered to utilize a high fraction of this diverse stream of breakdown products, and whether the carbon can be efficiently funneled into pathways that produce a high yield of useful chemicals or intermediates. Another question for further research is whether the chemical nature of the breakdown products can be tailored with reaction conditions. Generating more acids and less aldehydes may lead to greater biological utilization. Further decrease in Mw is also likely to be possible with further optimization of reaction conditions.

While many questions remain to be answered for this new approach, it is offered some comments regarding economics. A key factor is the ratio of low molecular weight products generated per amount of H₂O₂ consumed during depolymerization. In the present work, to achieve Mw=950 g/mol one gram of H₂O₂ (pure basis) is consumed per 0.44 g of depolymerized product generated and to achieve Mw=700 g/mol one gram of H₂O₂ is consumed per 0.30 g of depolymerized product generated ([FeCl₃]=[DHB]=0.5 mM, T=40° C.). These values do not seem to be prohibitive, and higher yields will likely result with further optimization. Another concern is the amount of carbon lost as CO₂ in the process. It is established an upper bound of 20% of the original carbon that is lost as CO₂ or other volatile compounds such as MeOH, CH₂O, CH₂OOH, CH3COOH, and CH3CHO. Considering that ˜10% of the carbon is in the form of methanol from oxidation of methoxy groups, it is concluded that very little carbon is lost as CO₂ in this process. Whereas a large amount of relatively low-cost LS is currently available from the pulp and paper industry, lignin from a lignocellulosic biorefinery would need to be sulfonated, adding substantially to the process cost. Another factor impacting the economics of the process is the rate of throughput. The results in FIG. 3 and FIG. 6 indicate that repolymerization of fragments after C—C bond cleavage can be minimized at low [Fe] and low [LS], and these conditions will lower the rate of reaction and throughput. However, the results indicate that 5 mg/ml can be depolymerized from 28,000 g/mol to roughly 700 g/mol at 1 liter scale at 40° C. Given the rate required for biological growth and conversion this rate of throughout in the depolymerization step may not be limiting. Finally, CMF depolymerization of LS need not be considered in isolation, but rather could be used subsequent to a process that releases aromatic monomers. The fact that depolymerization occurs in aqueous solutions at mild conditions should allow the depolymerization and fermentation processes to be coupled and that should lower processing costs.

### CONCLUSIONS

Depolymerization of lignin followed by biological conversion of the breakdown products has the potential to supply valuable compounds that are currently derived from petroleum. However, for natural lignins isolated from carbohydrate-first pretreatment processes cleaving C—C bonds will be essential to recover a high fraction of the mass as low molecular weight products. Current approaches face challenges due to high cost, difficulty to avoid repolymerization, and toxicity of some of the products. Herein is presented an alternative approach, demonstrating that a chelator-mediated Fenton reaction efficiently cleaves C—C bonds in lignosulfonate at room temperature. It is also shown that repolymerization can be minimized through careful control of reagent concentrations and reaction temperature. Initial studies of growth of monocultures on the lignosulfonate depolymerization products show promise, especially when supplemented with a small amount of glucose.

### Example 2

### Method to Depolymerize Lignin Through Sulfonation and Chelator-Mediated Fenton Reaction

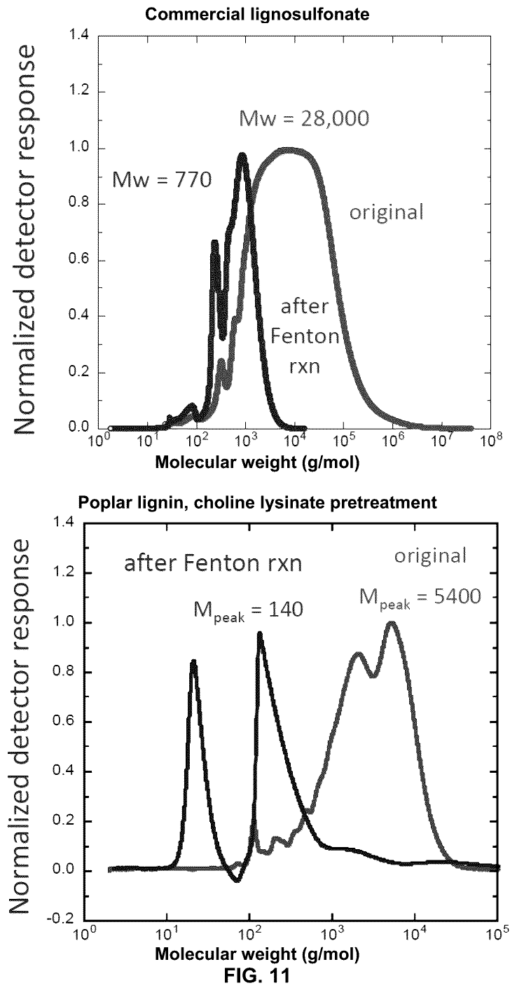

FIG. 11 shows the Fenton reaction depolymerizes sulfonated lignin at about room temperature (RT) in aqueous solution. Prior to the reaction the lignin or lignosulfonate (LS) (at about 5 mg/mL) is opaque and dark colored. After the reaction, the sample becomes transparent and clear.

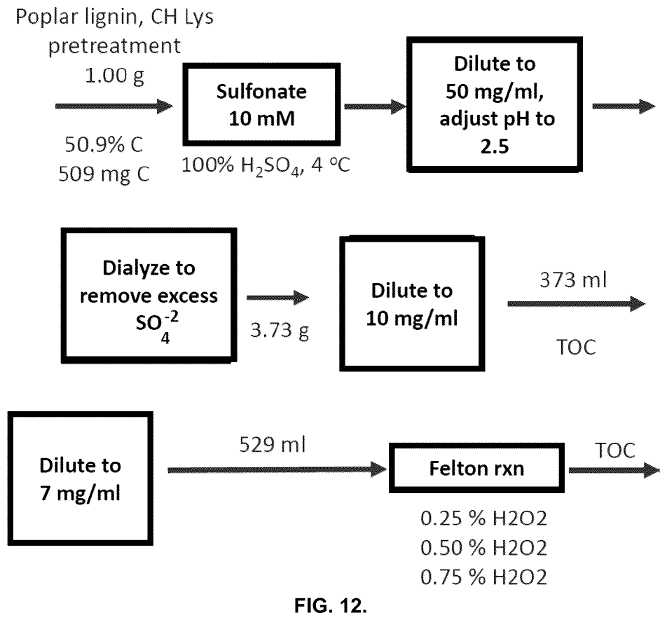

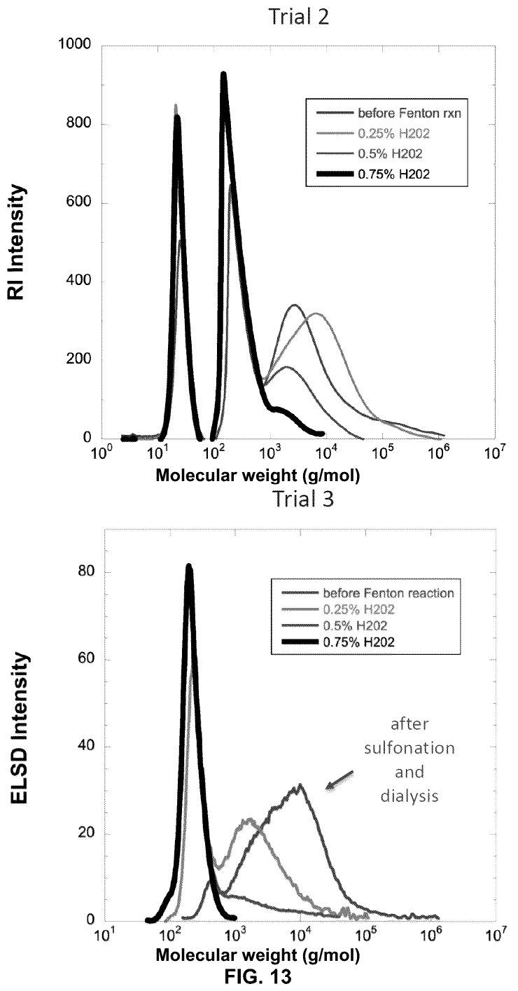

FIG. 12 shows a method of depolymerizing lignin for biological conversion through sulfonation and Fenton chemistry. FIG. 13 shows the depolymerization of lignin for biological conversion through sulfonation and Fenton chemistry.

Very little carbon is lost in the reaction process. Based on data obtained for the commercial lignosulfonate sample, less than 20% of the carbon is lost. Sulfonation is very simple, fast, and inexpensive. It can be performed using only sulfuric acid, and can be performed at about RT. The amount of H₂O₂ used is very low (0.5 wt % to depolymerize 10 mg/ml lignin). A full TEA has not yet been done. Having the LS at a lower molecular weight improves its bioavailability absent toxicity. Sulfonation affects the extent of depolymerization, but may also contribute to toxicity. The amount of sulfonation can be varied to determine the optimum amount of sulfonation in order to obtain the highest bioavailability.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method to break a C—C bond in lignosulfonate, the method comprising: (a) contacting a chelator/Fe complex or a Fe(II) cation with a lignosulfonate to produce a reaction mixture, and (b) incubating the reaction mixture for a suitable period of time wherein at least one C—C bond in a lignosulfonate is broken resulting in at least two separate molecules formed from the breaking of one C—C bond in the lignosulfonate; where each separate molecule has a different molecular weight from the other.

2. The method of claim 1, the method comprising: sulfonating a lignin to produce the lignosulfonate; wherein the sulfonating steps occurs prior to the contacting step (a).

3. The method of claim 1, the method comprising: (c) introducing an oxidizing agent to the reaction mixture.

4. The method of claim 3, the method comprising: (d) separating the two separate molecules formed from breaking of one C—C bond of lignosulfonate.

5. The method of claim 2, wherein the sulfonating step comprises contacting a lignin with a sulfite or sulfuric acid.

6. The method of claim 5, wherein the sulfite is an acidic sulfite, calcium sulfite, or sodium sulfite.

7. The method of claim 5, wherein the sulfonating step comprises further contacting the lignin with a base.

8. The method of claim 7, wherein the base is sodium hydroxide or calcium oxide.

9. The method of claim 2, wherein the sulfonating step comprises contacting a lignin with a base with a lignin, and then contacting the lignin with a hydroxymethylsulfonate.

10. The method of claim 1, the method further comprises: contacting a Fe salt and a chelator to form the chelator/Fe complex.

11. A mixture of lignosulfonate molecules formed by the breaking of C—C bonds using the method of claim 1.
